(19) United States
(12) Patent Application Publication
(10) Pub. No.: US 2025/0284595 A1
(43) Pub. Date: Sep. 11, 2025

(54) Kubernetes Namespace Snapshot, Backup, and Restore Functionality

(71) Applicant: Rakuten Symphony, Inc., Tokyo (JP)

(72) Inventor: Thomas Jay Morano, Scotts Valley, CA (US)

(21) Appl. No.: 18/245,787

(22) PCT Filed: Nov. 10, 2022
(86) PCT No.: PCT/US2022/049560

§ 371 Date: Mar. 17, 2023

(51) Int. Cl. G06F 11/14

(52) U.S. Cl. CPC G06F 11/1451; G06F 11/1464; G06F 11/1466

(57) ABSTRACT

A method comprising identifying one or more application resources associated with one or more applications, wherein the one or more applications is associated with a namespace, identifying a plurality of persistent volume claims, identifying a plurality of storage volumes associated with the namespace, wherein each of the plurality of storage volumes is bound to at least one of the plurality of persistent volume claims, pausing transactions executed on each of the plurality of storage volumes, capturing a snapshot of each of the plurality of storage volumes, creating a copy of the one or more application resources, and capturing a namespace snapshot by capturing the snapshots of each of the plurality of storage volumes and the copy of the one or more application resources.

### TECHNICAL FIELD

The present disclosure relates generally to application snapshot functionality for distributed cloud-network architectures, and specifically relates to actions associated with snapshot functionality within a distributed cloud-network architecture.

### SUMMARY

Systems and methods for creating a snapshot of one or more cloud-network architecture framework resources. The method includes identifying one or more application resources associated with one or more applications, wherein the one or more applications is associated with a namespace, identifying a plurality of persistent volume claims, identifying a plurality of storage volumes associated with the namespace, wherein each of the plurality of storage volumes is bound to at least one of the plurality of persistent volume claims, pausing transactions executed on each of the plurality of storage volumes, capturing a snapshot of each of the plurality of storage volumes, creating a copy of the one or more application resources, and capturing a namespace snapshot by capturing the snapshots of each of the plurality of storage volumes and the copy of the one or more application resources.

### BACKGROUND

Cloud-network architecture frameworks, for example, Kubernetes, are regularly employed for managing complex applications in a containerized environment. They provide various facilities for managing container placement, resource allocation, service discovery, load balancing, scaling, etc.

Within such frameworks, on a cluster, a pod is the basic operational unit. Within a pod there may be one or more containers, which can be deployed as individual units or deployed under the control of various resource controllers. Users are able to decide how to define a set of related resources in various configurations of resource units. For managing the life cycle of a complex application made up of various resources, there is a lack of a proper construct to handle such complex applications in a time-and resource-efficient manner.

Additionally, taking snapshots of storage volumes has existed for decades in the industry. However, when an application is distributed and/or uses multiple storage volumes across one or more pods, orchestrating storage-only snapshots across all of them is tedious, error-prone and inconsistent. Storage-only snapshots are also unaware of the application configuration and its topology, which makes cloning, backing up or restoring cumbersome and prone to misconfiguration.

An application snapshot/backup only contains data and metadata for a single application. Often there are multiple applications and resources deployed in a Kubernetes namespace. There is a need for an application construct that can effectively managed the resources of complex applications in a Kubernetes cluster as well as way to create a snapshot of the data and metadata for all applications and objects bound to a namespace, and also a way to push the snapshot as a backup to an external storage repository.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1A is a schematic block diagram of a system for automated deployment, scaling, and management of containerized workloads and services, wherein the system draws on storage distributed across shared storage resources.

FIG. 1B is a schematic block diagram of a system for automated deployment, scaling, and management of containerized workloads and services, wherein the system draws on storage within a stacked storage cluster.

FIG. 2 is a schematic block diagram of a system for automated deployment, scaling, and management of containerized applications.

FIG. 3 is a schematic block diagram illustrating a system for managing containerized workloads and services.

FIG. 4 is a schematic block diagram illustrating a system for implementing an application-orchestration approach to data management and allocation of processing resources.

FIG. 5 is a schematic block diagram illustrating an example application bundle.

FIG. 6 shows a schematic diagram of capturing a snapshot.

FIG. 7 shows a schematic diagram of importing a snapshot to a cluster.

FIG. 8 shows a schematic diagram of populating a cluster with a snapshot from external storage.

FIG. 9 shows a flowchart diagram of method steps of a software method for creating a snapshot.

FIG. 10 shows a flowchart diagram of method steps of a software method for creating a namespace from a snapshot.

FIG. 11 shows a schematic block diagram of an example computing device.

### DETAILED DESCRIPTION

The present disclosure generally relates to a framework for managing stateful applications deployed on a cluster. An application and all its resources that together deliver a service to the end user may be collected into a single application unit, such as an application bundle. A manifest may be included that maintains metadata on each of the application's associated resources in a configuration database. This facilitates life cycle management operations, such as snapshot, backup, restore, etc., that encompass all of an application's data and metadata, including the state of each resource.

Grouping application containers and their resource specifications together into an application bundle allows users to define a new data organization structure that allows a user to manage resources and operations quickly and efficiently within the application bundle. By creating a snapshot of an application bundle, a user may be able to create a consistent snapshot across an entire application, and may capture the topology of the application itself and the data volumes employed by that application. Once captured, these snapshots may be backed up to an external repository, used as a system restore point, or used to clone an application to another system or cluster.

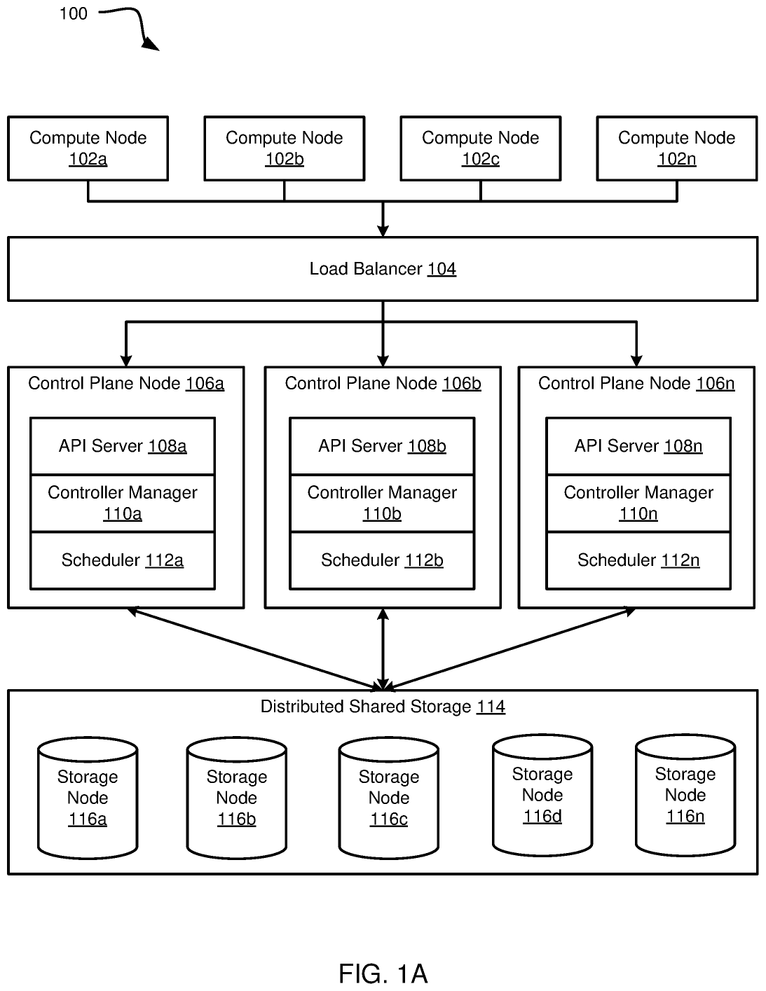

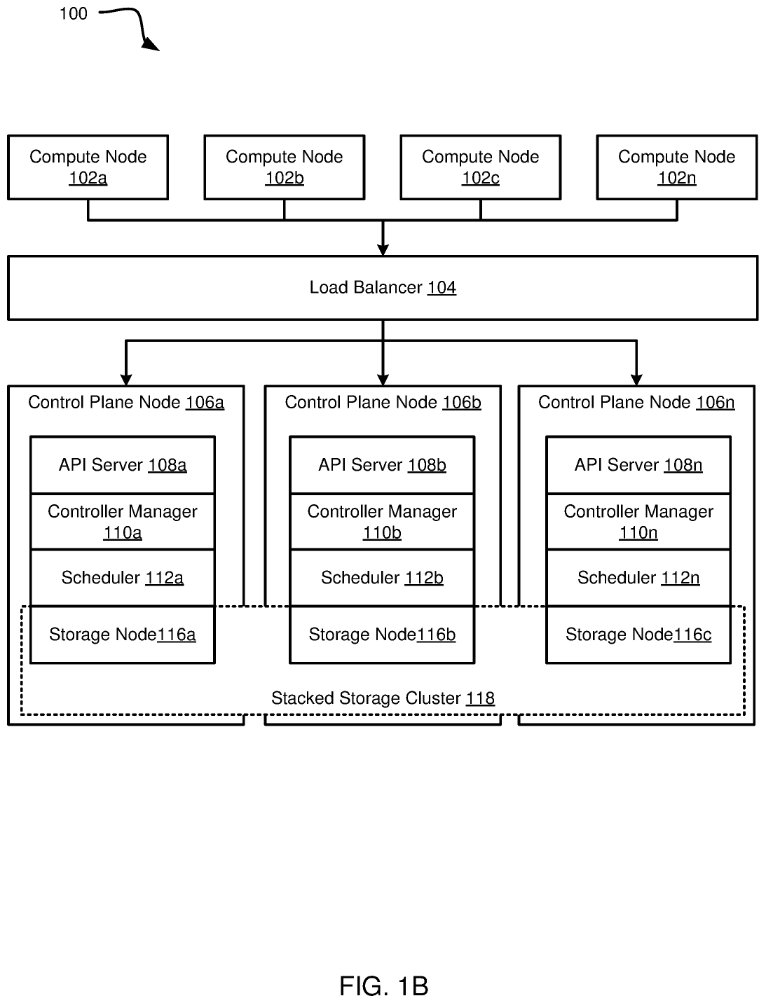

Referring now to the figures, FIGS. 1A and 1B are schematic illustrations of an example system 100 for automated deployment, scaling, and management of containerized workloads and services. The system 100 facilitates declarative configuration and automation through a distributed platform that orchestrates different compute nodes that may be controlled by central master nodes. The system 100 may include “n” number of compute nodes that can be distributed to handle pods.

The system 100 includes a plurality of compute nodes 102a, 102b, 102c, 102n (may collectively be referred to as compute nodes 102 as discussed herein) that are managed by a load balancer 104. The load balancer 104 assigns processing resources from the compute nodes 102 to one or more of the control plane nodes 106a, 106b, 106n (may collectively be referred to as control plane nodes 106 as discussed herein) based on need. In the example implementation illustrated in FIG. 1A, the control plane nodes 106 draw upon a distributed shared storage 114 resource comprising a plurality of storage nodes 116a, 116b 116c, 116d, 116n (may collectively be referred to as storage nodes 116 as discussed herein). In the example implementation illustrated in FIG. 1B, the control plane nodes 106 draw upon assigned storage nodes 116 within a stacked storage cluster 118.

The control planes 106 make global decisions about each cluster and detect and responds to cluster events, such as initiating a pod when a deployment replica field is unsatisfied. The control plane node 106 components may be run on any machine within a cluster. Each of the control plane nodes 106 includes an API server 108, a controller manager 110, and a scheduler 112.

The API server 108 functions as the front end of the control plane node 106 and exposes an Application Program Interface (API) to access the control plane node 106 and the compute and storage resources managed by the control plane node 106. The API server 108 communicates with the storage nodes 116 spread across different clusters. The API server 108 may be configured to scale horizontally, such that it scales by deploying additional instances. Multiple instances of the API server 108 may be run to balance traffic between those instances.

The controller manager 110 embeds core control loops associated with the system 100. The controller manager 110 watches the shared state of a cluster through the API server 108 and makes changes attempting to move the current state of the cluster toward a desired state. The controller manager 110 may manage one or more of a replication controller, endpoint controller, namespace controller, or service accounts controller.

The scheduler 112 watches for newly created pods without an assigned node, and then selects a node for those pods to run on. The scheduler 112 accounts for individual and collective resource requirements, hardware constraints, software constraints, policy constraints, affinity specifications, anti-affinity specifications, data locality, inter-workload interference, and deadlines.

The storage nodes 116 function as a distributed storage resources with backend service discovery and database. The storage nodes 116 may be distributed across different physical or virtual machines. The storage nodes 116 monitor changes in clusters and store state and configuration data that may be accessed by a control plane node 106 or a cluster. The storage nodes 116 allow the system 100 to support discovery service so that deployed applications can declare their availability for inclusion in service.

In some implementations, the storage nodes 116 are organized according to a key-value store configuration, although the system 100 is not limited to this configuration. The storage nodes 116 may create a database page for each record such that the database pages do not hamper other records while updating one. The storage nodes 116 may collectively maintain two or more copies of data stored across all clusters on distributed machines.

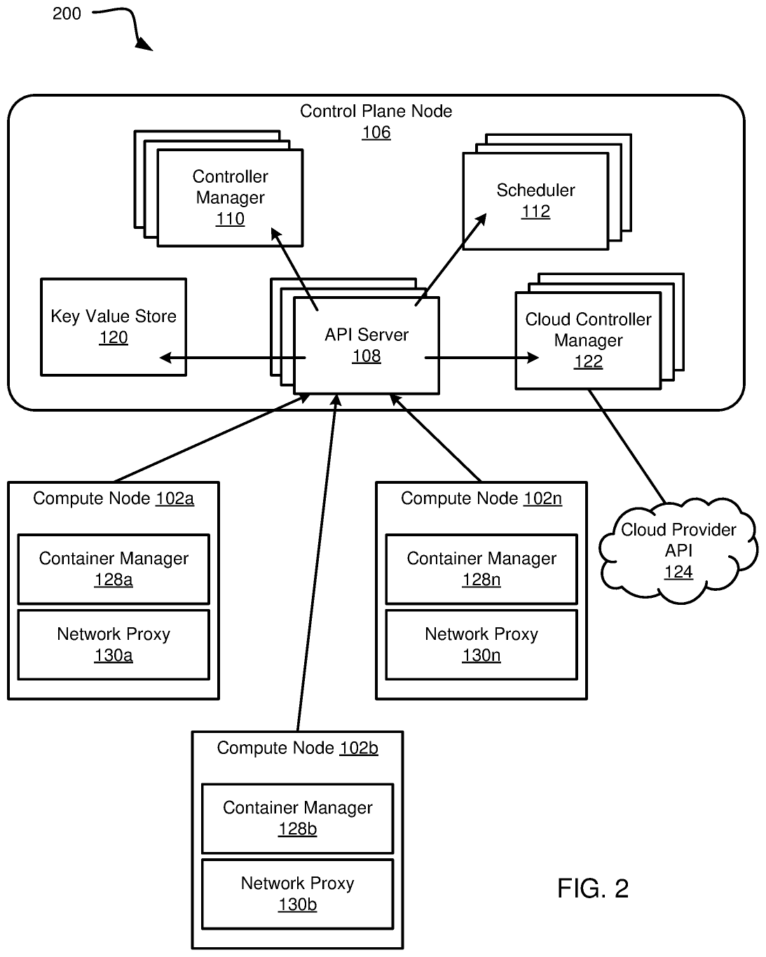

FIG. 2 is a schematic illustration of a cluster 200 for automating deployment, scaling, and management of containerized applications. The cluster 200 illustrated in FIG. 2 is implemented within the systems 100 illustrated in FIGS. 1A-1B, such that the control plane node 106 communicates with compute nodes 102 and storage nodes 116 as shown in FIGS. 1A-1B. The cluster 200 groups containers that make up an application into logical units for management and discovery.

The cluster 200 deploys a cluster of worker machines, identified as compute nodes 102a, 102b, 102n. The compute nodes 102a-102n run containerized applications, and each cluster has at least one node. The compute nodes 102a-102n host pods that are components of an application workload. The compute nodes 102a-102n may be implemented as virtual or physical machines, depending on the cluster. The cluster 200 includes a control plane node 106 that manages compute nodes 102a-102n and pods within a cluster. In a production environment, the control plane node 106 typically manages multiple computers and a cluster runs multiple nodes. This provides fault tolerance and high availability.

The key value store 120 is a consistent and available key value store used as a backing store for cluster data. The controller manager 110 manages and runs controller processes. Logically, each controller is a separate process, but to reduce complexity in the cluster 200, all controller processes are compiled into a single binary and run in a single process. The controller manager 110 may include one or more of a node controller, job controller, endpoint slice controller, or service account controller.

The cloud controller manager 122 embeds cloud-specific control logic. The cloud controller manager 122 enables clustering into a cloud provider API 124 and separates components that interact with the cloud platform from components that only interact with the cluster. The cloud controller manager 122 may combine several logically independent control loops into a single binary that runs as a single process. The cloud controller manager 122 may be scaled horizontally to improve performance or help tolerate failures.

The control plane node 106 manages any number of compute nodes 126. In the example implementation illustrated in FIG. 2, the control plane node 106 is managing three nodes, including a first node 126a, a second node 126b, and an nth node 126n (which may collectively be referred to as compute nodes 126 as discussed herein). The compute nodes 126 each include a container manager 128 and a network proxy 130.

The container manager 128 is an agent that runs on each compute node 126 within the cluster managed by the control plane node 106. The container manager 128 ensures that containers are running in a pod. The container manager 128 may take a set of specifications for the pod that are provided through various mechanisms, and then ensure those specifications are running and healthy.

The network proxy 130 runs on each compute node 126 within the cluster managed by the control plane node 106. The network proxy 130 maintains network rules on the compute nodes 126 and allows network communication to the pods from network sessions inside or outside the cluster.

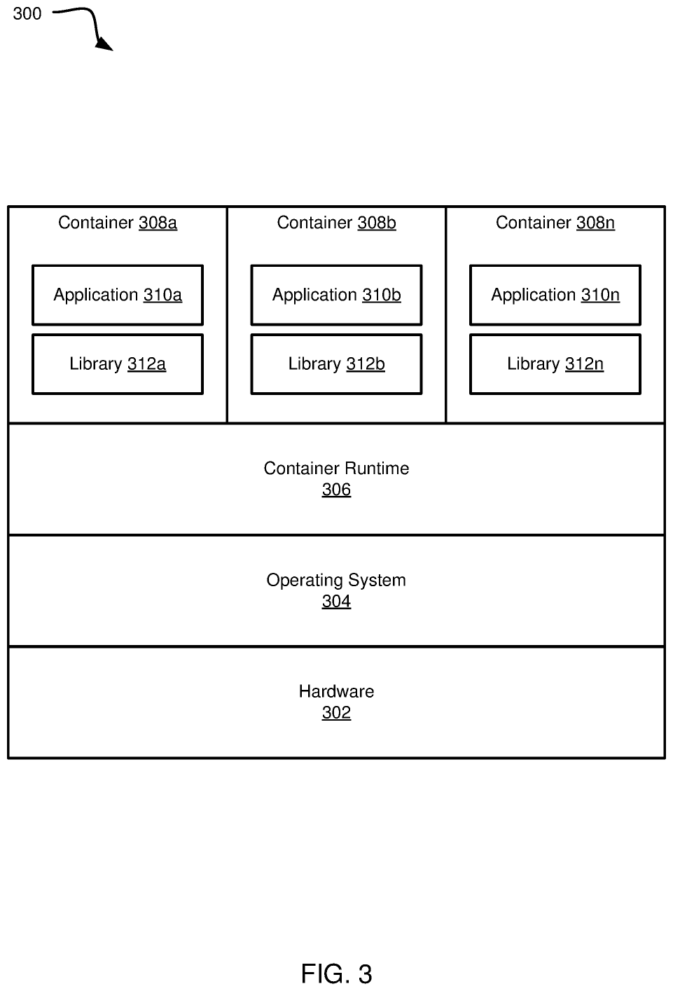

FIG. 3 is a schematic diagram illustrating a system 300 for managing containerized workloads and services. The system 300 includes hardware 302 that supports an operating system 304 and further includes a container runtime 306, which refers to the software responsible for running containers 308. The hardware 302 provides processing and storage resources for a plurality of containers 308a, 308b, 308n that each run an application 310 based on a library 312. The system 300 discussed in connection with FIG. 3 is implemented within the systems 100, 200 described in connection with FIGS. 1A-1B and 2.

The containers 308 function similar to a virtual machine but have relaxed isolation properties and share an operating system 304 across multiple applications 310. Therefore, the containers 308 are considered lightweight. Similar to a virtual machine, a container has its own file systems, share of CPU, memory, process space, and so forth. The containers 308 are decoupled from the underlying instruction and are portable across clouds and operating system distributions.

Containers 308 are repeatable and may decouple applications from underlying host infrastructure. This makes deployment easier in different cloud or OS environments. A container image is a ready-to-run software package, containing everything needed to run an application, including the code and any runtime it requires, application and system libraries, and default values for essential settings. By design, a container 308 is immutable such that the code of a container 308 cannot be changed after the container 308 begins running.

The containers 308 enable certain benefits within the system. Specifically, the containers 308 enable agile application creation and deployment with increased ease and efficiency of container image creation when compared to virtual machine image use. Additionally, the containers 308 enable continuous development, integration, and deployment by providing for reliable and frequent container image build and deployment with efficient rollbacks due to image immutability. The containers 308 enable separation of development and operations by creating an application container at release time rather than deployment time, thereby decoupling applications from infrastructure. The containers 308 increase observability at the operating system-level, and also regarding application health and other signals. The containers 308 enable environmental consistency across development, testing, and production, such that the applications 310 run the same on a laptop as they do in the cloud. Additionally, the containers 308 enable improved resource isolation with predictable application 310 performance. The containers 308 further enable improved resource utilization with high efficiency and density.

The containers 308 enable application-centric management and raise the level of abstraction from running an operating system 304 on virtual hardware to running an application 310 on an operating system 304 using logical resources. The containers 304 are loosely coupled, distributed, elastic, liberated micro-services. Thus, the applications 310 are broken into smaller, independent pieces and can be deployed and managed dynamically, rather than a monolithic stack running on a single-purpose machine.

The containers 308 may include any container technology known in the art such as DOCKER, LXC, LCS, KVM, or the like. In a particular application bundle 406, there may be containers 308 of multiple distinct types in order to take advantage of a particular container's capabilities to execute a particular role 416. For example, one role 416 of an application bundle 406 may execute a DOCKER container 308 and another role 416 of the same application bundle 406 may execute an LCS container 308.

The system 300 allows users to bundle and run applications 310. In a production environment, users may manage containers 308 and run the applications to ensure there is no downtime. For example, if a singular container 308 goes down, another container 308 will start. This is managed by the control plane nodes 106, which oversee scaling and failover for the applications 310.

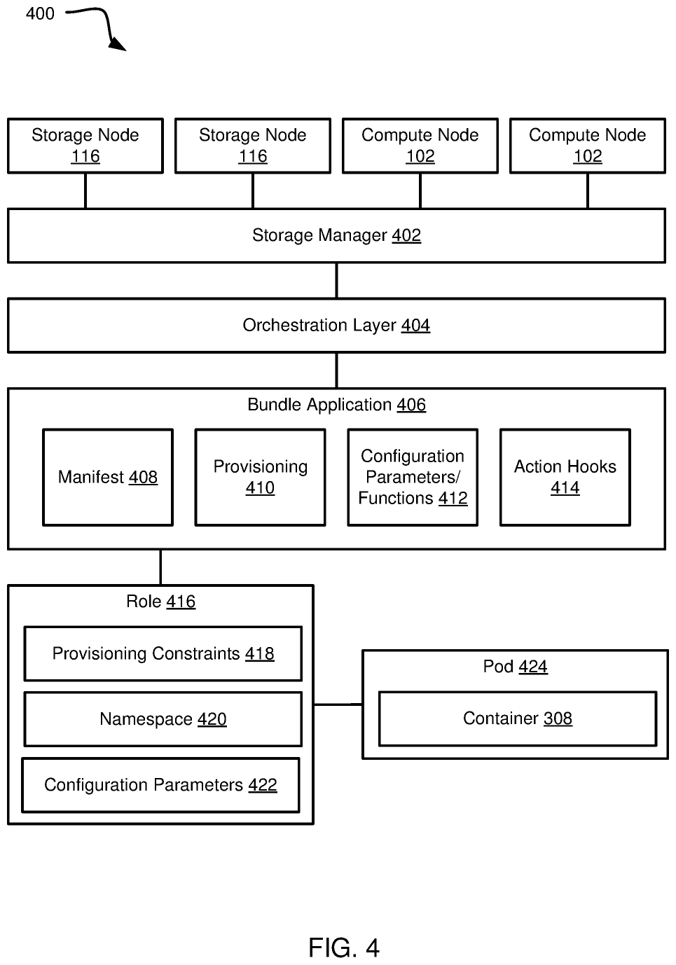

FIG. 4 is a schematic diagram of an example system 400 implementing an application-orchestration approach to data management and the allocation of processing resources. The system 400 includes an orchestration layer 404 that implements an application bundle 406 including one or more roles 416. The role 416 may include a standalone application, such as a database, webserver, blogging application, or any other application. Examples of roles 416 include the roles used to implement multi-role applications such as CASSANDRA, HADOOP, SPARK, DRUID, SQL database, ORACLE database, MONGODB database, WORDPRESS, and the like. For example, in HADOOP, roles 416 may include one or more of a named node, data node, zookeeper, and AMBARI server.

The orchestration layer 404 implements an application bundle 406 by defining roles 416 and relationships between roles 416. The orchestration layer 404 may execute on a computing device of a distributed computing system (see, e.g., the systems illustrated in FIGS. 1A-1B and 2-3), such as on a compute node 102, storage node 116, a computing device executing the functions of the control plane node 106, or some other computing device. Accordingly, actions performed by the orchestration layer 404 may be interpreted as being performed by the computing device executing the orchestration layer 404.

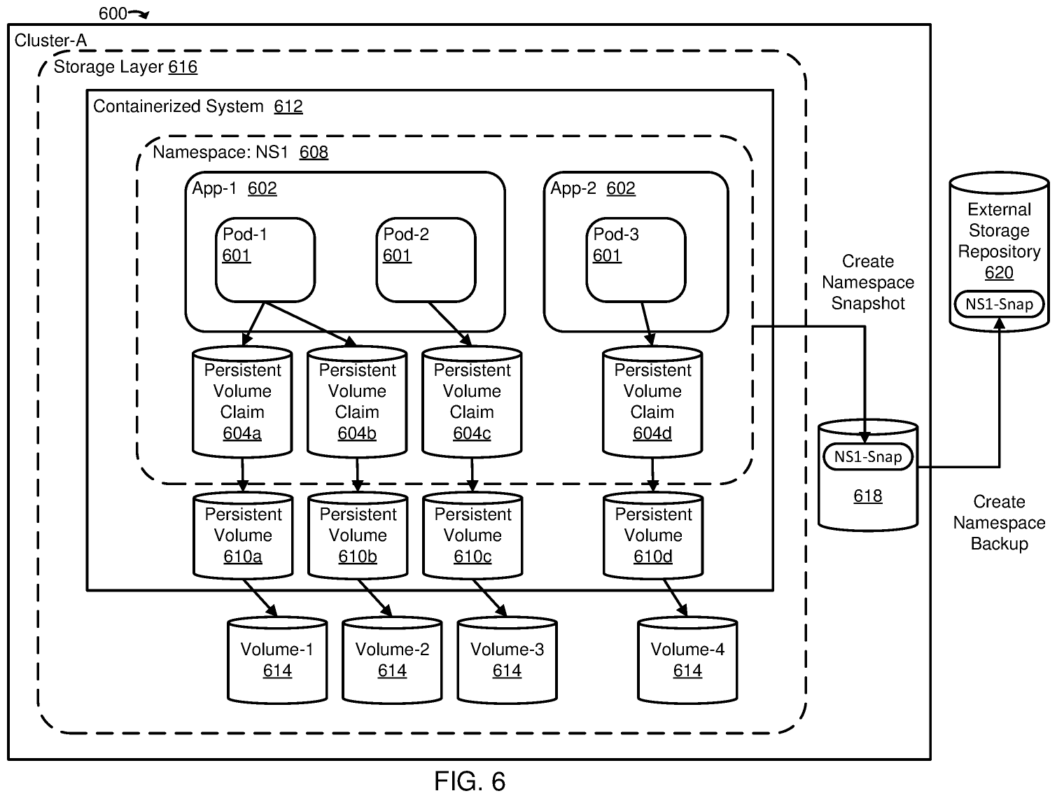

The application bundle 406 includes a manifest 408 and artifacts describing an application. The application bundle 406 itself does not take any actions. When the application bundle 406 is deployed by compute resources, the application bundle 406 is then referred to as a “bundle application.” This is discussed in connection with FIG. 6, which illustrates deployment of the application bundle 406 to generate a bundle application 606 comprising one or more pods 424 and containers 308 run on compute nodes 102 within a cluster 200.

The application bundle 406 includes a manifest 408 that defines the roles 416 of the application bundle 406, which may include identifiers of roles 416 and possibly a number of instances for each role 416 identified. The manifest 408 defines dynamic functions based on the number of instances of a particular role 416, which may grow or shrink in real-time based on usage. The orchestration layer 404 creates or removes instances for a role 416 as described below as indicated by usage and one or more functions for that role 416. The manifest 408 defines a topology of the application bundle 406, which includes the relationships between roles 416, such as services of a role that are accessed by another role.

The application bundle 406 includes a provisioning component 410. The provisioning component 410 defines the resources of storage nodes 116 and compute nodes 102 required to implement the application bundle 406. The provisioning component 410 defines the resources for the application bundle 406 as a whole or for individual roles 416. The resources may include a number of processors (e.g., processing cores), an amount of memory (e.g., RAM (random access memory), an amount of storage (e.g., GB (gigabytes) on an HDD (Hard Disk Drive) or SSD (Solid State Drive)), and so forth. As described below, these resources may be provisioned in a virtualized manner such that the application bundle 406 and individual roles 416 are not informed of the actual location or processing and storage resources and are relieved from any responsibility for managing such resources.

The provisioning component 410 implements static specification of resources and may also implement dynamic provisioning functions that invoke allocation of resources in response to usage of the application bundle 406. For example, as a database fills up, additional storage volumes may be allocated. As usage of an application bundle 406 increases, additional processing cores and memory may be allocated to reduce latency.

The application bundle 406 may include configuration parameters 412. The configuration parameters include variables and settings for each role 416 of the application bundle 406. The developer of the role defines the configuration parameters 416 and therefore may include any example of such parameters for any application known in the art. The configuration parameters may be dynamic or static. For example, some parameters may be dependent on resources such as an amount of memory, processing cores, or storage. Accordingly, these parameters may be defined as a function of these resources. The orchestration layer will then update such parameters according to the function in response to changes in provisioning of those resources that are inputs to the function.

The application bundle 406 may further include action hooks 414 for various life cycle actions that may be taken with respect to the application bundle 406 and/or particular roles 416 of the application bundle 406. Actions may include some or all of stopping, starting, restarting, taking snapshots, cloning, and rolling back to a prior snapshot. For each action, one or more action hooks 414 may be defined. An action hook 414 is a programmable routine that is executed by the orchestration layer 404 when the corresponding action is invoked. The action hook 414 may specify a script of commands or configuration parameters input to one or more roles 416 in a particular order. The action hooks 414 for an action may include a pre-action hook (executed prior to implementing an action), an action hook (executed to actually implement the action), and a post action hook (executed following implementation of the action).

The application bundle 406 defines one or more roles 416. Each role 416 may include one or more provisioning constraints. As noted above, the application bundle 406 and the roles 416 are not aware of the underlying storage nodes 106 and compute nodes 116 inasmuch as these are virtualized by the storage manager 402 and orchestration layer 404. Accordingly, any constraints on allocation of hardware resources may be included in the provisioning constraints 410. As described in greater detail below, this may include constraints to create separate fault domains in order to implement redundancy and constraints on latency.

The role 416 references the namespace 420 defined by the application bundle 406. All pods 424 associated with the application bundle 406 are deployed in the same namespace 420. The namespace 420 includes deployed resources like pods, services, configmaps, daemonsets, and others specified by the role 416. In particular, interfaces and services exposed by a role may be included in the namespace 420. The namespace 420 may be referenced through the orchestration layer 404 by an addressing scheme, e.g. <Bundle ID>.<Role ID>.<Name>. In some embodiments, references to the namespace 420 of another role 416 may be formatted and processed according to the JINJA template engine or some other syntax. Accordingly, each role 416 may access the resources in the namespace 420 in order to implement a complex application topology.

A role 416 may further include various configuration parameters 422 defined by the role, i.e. as defined by the developer that created the executable for the role 416. As noted above, these parameters may be set by the orchestration layer 404 according to the static or dynamic configuration parameters 422. Configuration parameters 422 may also be referenced in the namespace 420 and be accessible (for reading and/or writing) by other roles 416.

Each role 416 within the application bundle 406 maps to a pod 424. Each of the one or more pods 424 includes one or more containers 308. Each resource allocated to the application bundle 406 is mapped to the same namespace 420.

The pods 424 are the smallest deployable units of computing that may be created and managed in the systems described herein. The pods 424 constitute groups of one or more containers 308, with shared storage and network resources, and a specification of how to run the containers 308. The pods' 502 containers are co-located and co-scheduled and run in a shared context. The pods 424 are modeled on an application-specific “logical host,” i.e., the pods 424 include one or more application containers 308 that are relatively tightly coupled. In non-cloud contexts, application bundles 406 executed on the same physical or virtual machine are analogous to cloud applications executed on the same logical host.

The pods 424 are designed to support multiple cooperating processes (as containers 308) that form a cohesive unit of service. The containers 308 in a pod 424 are co-located and co-scheduled on the same physical or virtual machine in the cluster. The containers 308 can share resources and dependencies, communicate with one another, and coordinate when and how they are terminated. The pods 424 may be designed as relatively ephemeral, disposable entities. When a pod 424 is created, the new pod 424 is schedule to run on a node in the cluster. The pod 424 remains on that node until the pod 424 finishes executing, and then the pod 424 is deleted, evicted for lack of resources, or the node fails.

In some implementations, the shared context of a pod 424 is a set of Linux® namespaces, cgroups, and potentially other facets of isolation, which are the same components of a container 308. The pods 424 are similar to a set of containers 308 with shared filesystem volumes.

The pods 424 can specify a set of shared storage volumes. All containers 308 in the pod 424 can access the shared volumes, which allows those containers 308 to share data. Volumes allow persistent data in a pod 424 to survive in case one of the containers 308 within needs to be restarted.

In some cases, each pod 424 is assigned a unique IP address for each address family. Every container 308 in a pod 424 shares the network namespace, including the IP address and network ports. Inside a pod 424, the containers that belong to the pod 424 can communicate with one another using localhost. When containers 308 in a pod 424 communicate with entities outside the pod 424, they must coordinate how they use the shared network resources. Within a pod 424, containers share an IP address and port space, and can find each other via localhost. The containers 308 in a pod 424 can also communicate with each other using standard inter-process communications.

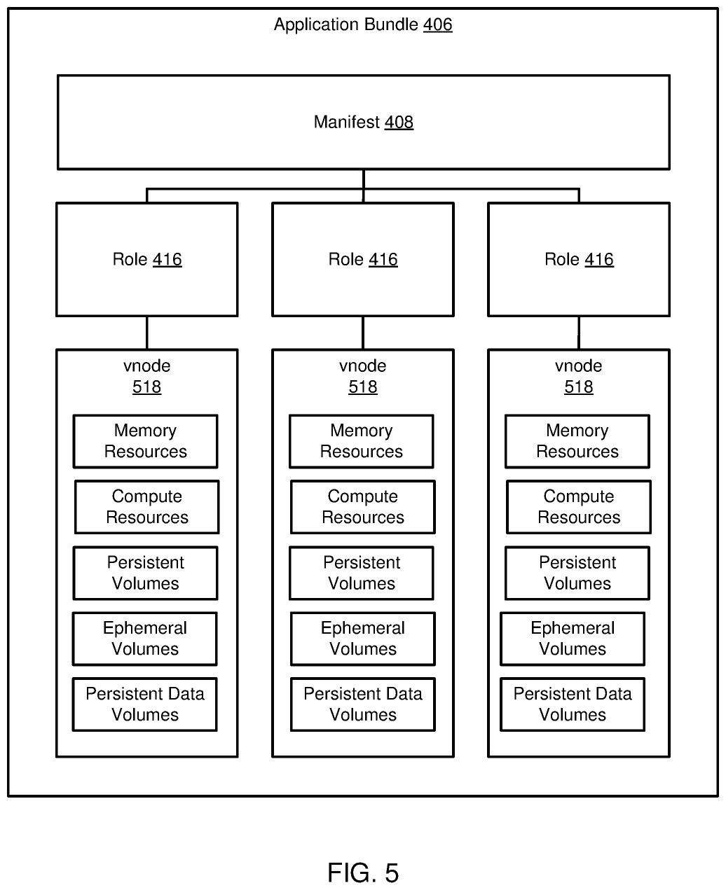

FIG. 5 is a schematic illustrations of an example application bundle 406 that may be executed by the systems described herein. The application bundle 406 is a collection of artifacts required to deploy and manage an application. The application bundle 406 includes one or more application container images referenced within a manifest 408 file that describes the components of its corresponding application bundle 406. The manifest 408 file further defines the necessary dependencies between services, resource requirements, affinity and non-affinity rules, and custom actions required for application management. As a result, a user may view the application bundle 406 as the starting point for creating an application within the systems described herein.

The application bundle 406 includes the manifest 408 file, and further optionally includes one or more of an icons directory, scripts directory, and source directory. The manifest 408 file may be implemented as a YAML file that acts as the blueprint for an application. The manifest 408 file describes the application components, dependencies, resource requirements, hookscripts, execution order, and so forth for the application. The icons directory includes application icons, and if no icon is provided, then a default image may be associated with the application bundle 406. The scripts directory includes scripts that need to be run during different stages of the application deployment. The scripts directory additionally includes lifecycle management for the application.

The example application bundle 406 illustrated in FIG. 5 includes a plurality of roles 416, but it should be appreciated that the application bundle 406 may have any number of roles 416, including one or more roles 416 as needed depending on the implementation. Each role 416 defines one or more vnodes 518. Each vnode 518 specifies container 308 resources for the corresponding role 416. The container resources include one or more of memory resources, compute resources, persistent volumes, persistent data volumes, and ephemeral data volumes. When the application bundle 406 is deployed in a cluster such as the cluster 200 illustrated in FIG. 2, each role 416 maps to a pod 424 and each vnode 518 maps to a container 308.

The manifest 408 file has several attributes that can be used to manipulate aspects of a container 308, including the compute node 102 resources and storage node 116 resources allocated to the containers 308, which containers 308 are spawned, and so forth. The application bundle 406 enables user to specify image and runtime engine options for each role 416. These options may include, for example name (name of the image), version (version of the image), and engine (type of runtime such as DOCKER, KVM, IXC, and so forth).

The manifest 408 file allocates compute resources such as memory, CPU, hugepages, GPU, and so forth, at the container 308 level. A user may specify the type of CPUs that should be picked, and may further specify options such as Non-Isolated, Isolated-Shared, and Isolated-Dedication. The Non-Isolated option indicates that the physical CPUs to be used for a deployment of the application bundle 406 should be from a non-isolated pool of CPUs on a host. The Isolated-Shared option indicates that the physical CPUs to be used for a deployment of the application bundle 406 should be from an isolated pool of CPUS on the host. With this option, even though the allocated CPUs are isolated from kernel processes, they can still be utilized by other application deployments. The Isolated-Dedicated option indicates that the physical CPUs to be used for a deployment of the application bundle 406 should be from an isolated pool of CPUs on the host. With this option, the allocated CPUs are isolated from kernel processes and other application deployments. The manifest 408 file further allocates storage resources at the container 308 level.

FIG. 6 is a schematic illustration showing a namespace snapshot 618 captured within a cloud-network architecture framework 600 being backed up to an external storage repository 620. A namespace snapshot may capture application 602 data, storage volume data, pod 601 data and resource metadata within the applications 602 for all applications deployed within a namespace. A namespace snapshot 618 may capture an application's 602 entire topology and configuration, including specifications of pods 601, services, StatefulSets, Secrets, ConfigMaps, and other specifications. Additionally, a namespace snapshot 618 may include data from persistent volume claims (PVCs) 604a, 604b, 604c, 604d (may collectively be referred to a persistent volume claims 604 as discussed herein) mounted to containers within those applications, as well as data from the persistent volumes (PVs) 610a, 610b, 610c, 610d (may collectively be referred to as persistent volumes 610 as discussed herein) created from storage volumes 614 within the storage layer 616. A snapshot may capture the state of every application, storage volume, resource configuration, etc. each at the same time the snapshot is captured. A snapshot may additionally capture other metadata and resources within the namespace, workflow states, transfers of data between applications and storage volumes, and undeployed application resources. Ephemeral (transient) storage volumes (not shown), if part of a namespace, may not be captured as part of a snapshot 618 and backed up to an external storage repository 620. In some implementations, information about the state of that ephemeral storage volume may be saved to a separate file and captured in a snapshot.

Application snapshots 618 may be exported as a backup and stored on an external storage repository 620. In some implementations, this may allow the original snapshot to be deleted, freeing up local storage space in some implementations if a user should desire. In other implementations, a user may prefer to keep a copy of the snapshot 618 within the framework 600. From the backup, a new application may be created having the same data and state as the original application. A user may create a new application within the same framework from which the snapshot originated, or in a different framework to which the snapshot 618 backup has been imported or cloned.

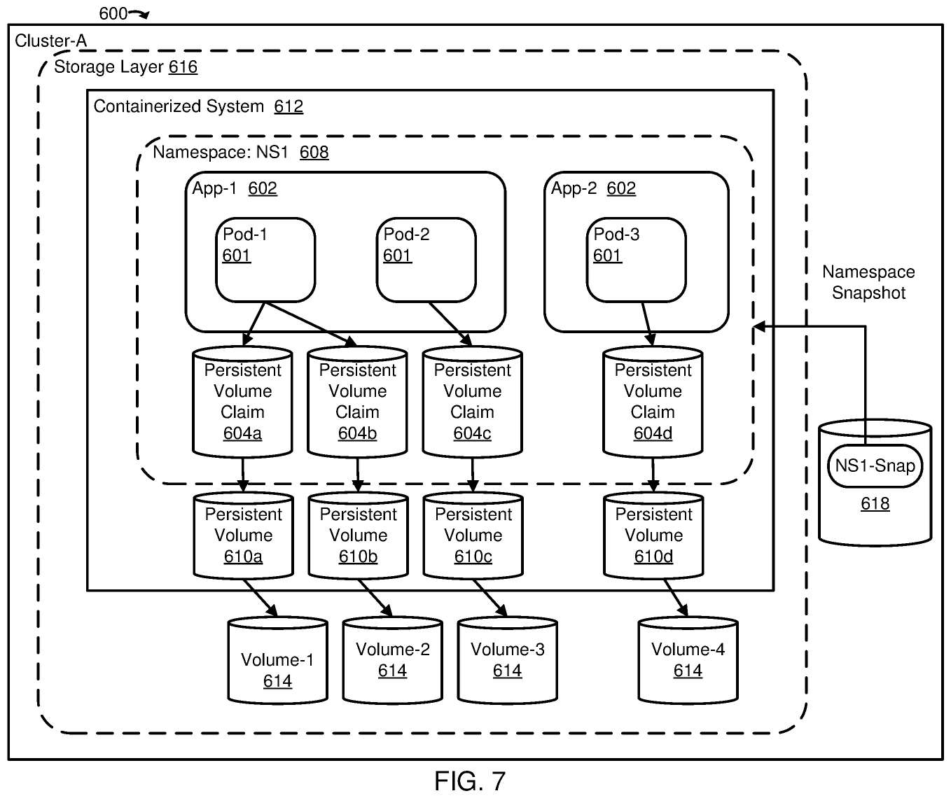

FIG. 7 shows a schematic illustration of restoring application data to a framework from a snapshot 610. A user may choose to restore data from a snapshot 618 for a variety of reasons. In some instances, for example, a system error may have occurred from which the application cannot recover, or in others some critical data may have been inadvertently deleted and incorrectly altered. A user may address these instances or others by restoring an application state from a snapshot 618, which may allow a user to revert the state of some or all data from applications 602, configuration files and other resources associated with those applications 602, persistent volumes 610, persistent volume claims 604, to the state at the time of the snapshot 618. The storage layer 616 may maintain details pertaining to all volume snapshots contained in the snapshot. When restoring a namespace 608 from a snapshot 618, the storage volumes 614 may be hydrated, or filled with data, using data blocks from the snapshot 618. Information about the data from storage volumes 614 and resource specification metadata (not shown) may be maintained by a cluster management plane 622 within a containerized system 612.

When restoring an application bundle, namespace, or framework from a snapshot 618, resources that were in the namespace 608 when the snapshot 618 was taken may exist in the namespace 608 prior to restoration. In some implementations, applications 602 that were deployed after the snapshot 618 was taken may need to be deleted before the resources in the namespace may be restored to their state from when the snapshot was taken. Persistent volumes referenced by persistent volume claims 610 bound to the namespace 618 may also be restored to their original state. In some implementations, a snapshot 618 may be created even when the namespace 608 contains application bundle resources or contains extra applications that were not in the namespace at the time of the snapshot.

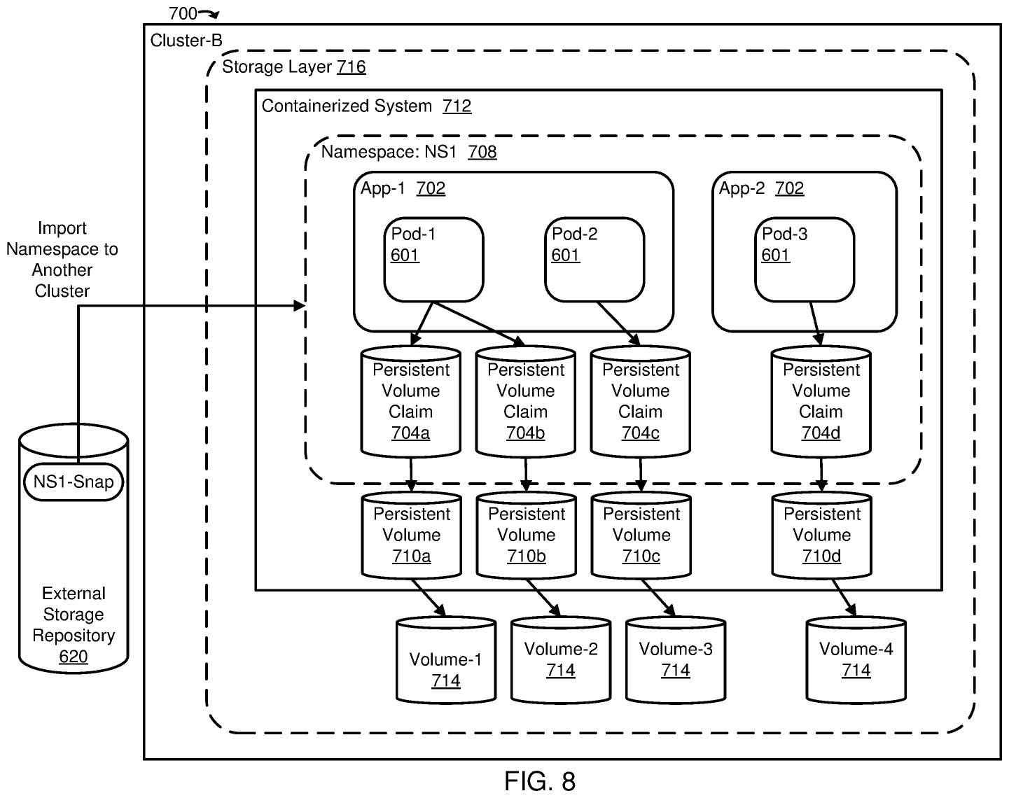

FIG. 8 shows a schematic diagram of using a snapshot 618 to clone an application bundle to another cluster 700. A snapshot 618 may be used to create a clone of a namespace, or a copy of all namespace resources, and use the clone to recreate the contents of the snapshot 618. A user may retrieve a snapshot 618 backup from an external storage repository 620 and utilize its contents to create a new instance of a containerized system 712, namespace 708, and all applications and data within the namespace 708. The instance of the containerized system 712 may specifically include an instance of the Kubernetes® platform. The data of the new instance may be populated with data from the snapshot's data, including snapshot data captured from storage volumes 714, persistent volumes 710a, 710b 710c, 710d, and persistent volume claims 704a, 704b, 704c, 704d. The data of the new instance may also include data from application bundles 702 and states and configuration files pertaining to application containers within those bundles captured by the snapshot. To import the snapshot 618 data, a user may hydrate storage volumes 714 using data from the volume data captured by the snapshot 618. A user may use the snapshot clone to create another instance of a same namespace for system redundancy in some implementations. In others, snapshots may be used to rapidly stand up a distributed system across many nodes and clusters efficiently.

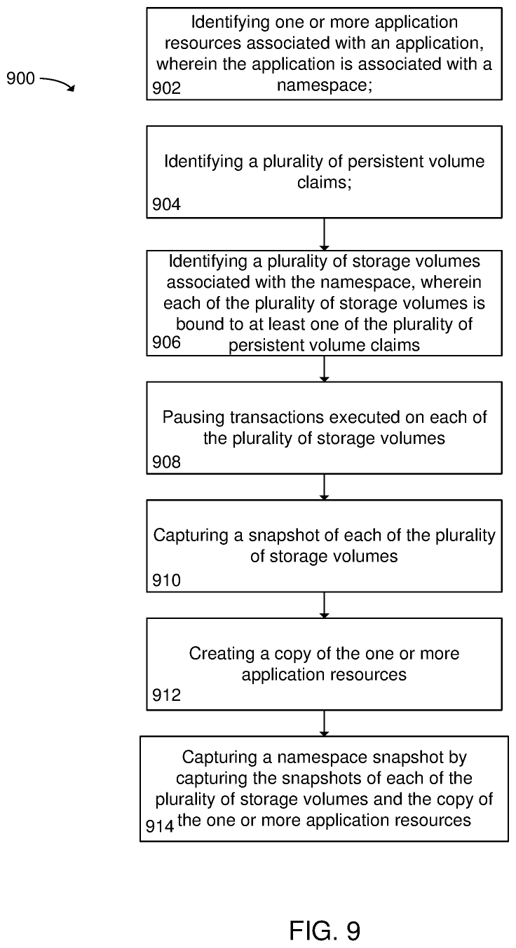

FIG. 9 shows a flowchart diagram of method steps for creating a snapshot 800. The steps may comprise identifying one or more application resources associated with an application, wherein the application is associated with a namespace 902, identifying a plurality of persistent volume claims 904, identifying a plurality of storage volumes associated with the namespace, wherein each of the plurality of storage volumes is bound to at least one of the plurality of persistent volume claims 906, pausing transactions executed on each of the plurality of storage volumes 908, capturing a snapshot of each of the plurality of storage volumes 910, creating a copy of the one or more application resources 912, capturing a namespace snapshot by capturing the snapshots of each of the plurality of storage volumes and the copy of the one or more application resources 914.

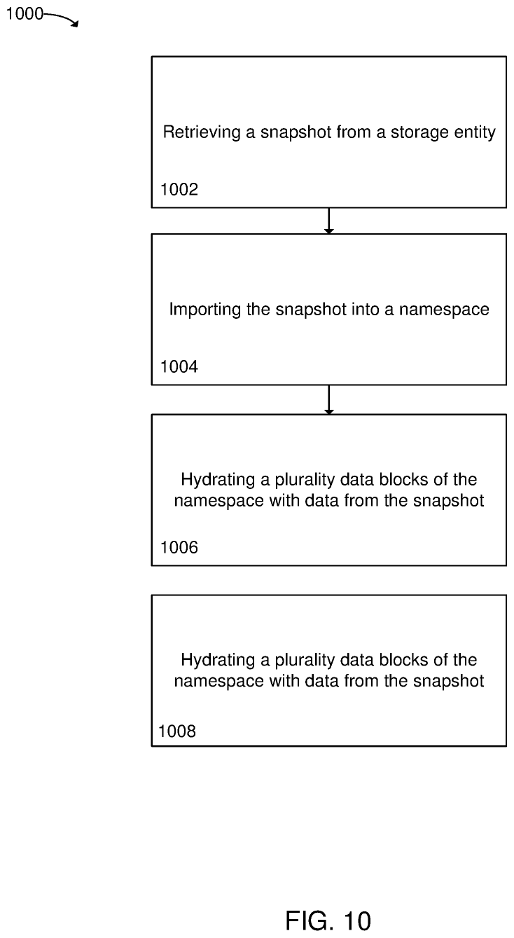

FIG. 10 shows a flowchart diagram of method steps for creating a namespace from a namespace's snapshot 900. The steps may comprise retrieving a snapshot from a storage volume 902, importing the snapshot into a namespace 904, verifying the namespace does not contain any applications that were not captured in the snapshot 906; and hydrating a plurality of data blocks of the namespace with data from the snapshot 908. The steps may further comprise wherein the namespace is a different namespace from the namespace from which the snapshot was captured, and wherein the namespace is a same namespace from which the snapshot was captured.

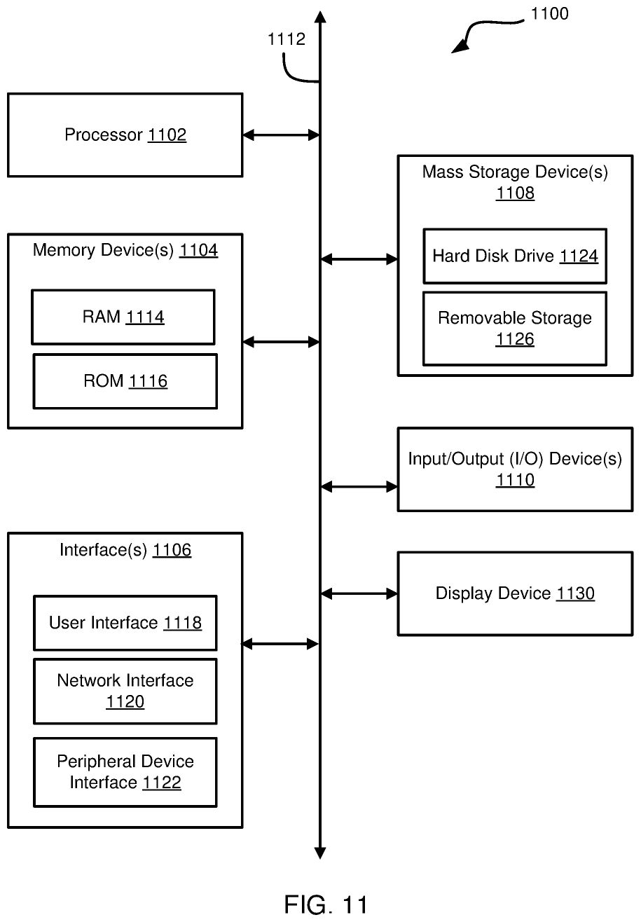

FIG. 11 illustrates a schematic block diagram of an example computing device 1100. The computing device 1100 may be used to perform various procedures, such as those discussed herein. The computing device 1100 can perform various monitoring functions as discussed herein, and can execute one or more application programs, such as the application programs or functionality described herein. The computing device 1100 can be any of a wide variety of computing devices, such as a desktop computer, in-dash computer, vehicle control system, a notebook computer, a server computer, a handheld computer, tablet computer and the like.

The computing device 1100 includes one or more processor(s) 1102, one or more memory device(s) 1104, one or more interface(s) 1106, one or more mass storage device(s) 1108, one or more Input/output (I/O) device(s) 1110, and a display device 1130 all of which are coupled to a bus 1112. Processor(s) 1104 include one or more processors or controllers that execute instructions stored in memory device(s) 1104 and/or mass storage device(s) 1108. Processor(s) 1104 may also include several types of computer-readable media, such as cache memory.

Memory device(s) 1104 include various computer-readable media, such as volatile memory (e.g., random access memory (RAM) 1114) and/or nonvolatile memory (e.g., read-only memory (ROM) 1116). Memory device(s) 1104 may also include rewritable ROM, such as Flash memory.

Mass storage device(s) 1108 include various computer readable media, such as magnetic tapes, magnetic disks, optical disks, solid-state memory (e.g., Flash memory), and so forth. As shown in FIG. 13, a particular mass storage device 1108 is a hard disk drive 1124. Various drives may also be included in mass storage device(s) 1108 to enable reading from and/or writing to the various computer readable media. Mass storage device(s) 1108 include removable media 1126 and/or non-removable media.

I/O device(s) 1110 include various devices that allow data and/or other information to be input to or retrieved from computing device 1100. Example I/O device(s) 1110 include cursor control devices, keyboards, keypads, microphones, monitors or other display devices, speakers, printers, network interface cards, modems, and the like.

Display device 1130 includes any type of device capable of displaying information to one or more users of computing device 1100. Examples of display device 1130 include a monitor, display terminal, video projection device, and the like.

Interface(s) 1106 include various interfaces that allow computing device 1100 to interact with other systems, devices, or computing environments. Example interface(s) 1106 may include any number of different network interfaces 1120, such as interfaces to local area networks (LANs), wide area networks (WANs), wireless networks, and the Internet. Other interface(s) include user interface 1118 and peripheral device interface 1122. The interface(s) 1106 may also include one or more user interface elements 1118. The interface(s) 1106 may also include one or more peripheral interfaces such as interfaces for printers, pointing devices (mice, track pad, or any suitable user interface now known to those of ordinary skill in the field, or later discovered), keyboards, and the like.

Bus 1112 allows processor(s) 1104, memory device(s) 1104, interface(s) 1106, mass storage device(s) 1108, and I/O device(s) 1110 to communicate with one another, as well as other devices or components coupled to bus 1112. Bus 1112 represents one or more of several types of bus structures, such as a system bus, PCI bus, IEEE bus, USB bus, and so forth.

For purposes of illustration, programs and other executable program components are shown herein as discrete blocks, such as block 1102 for example, although it is understood that such programs and components may reside at various times in different storage components of computing device 1100 and are executed by processor(s) 1102. Alternatively, the systems and procedures described herein, including programs or other executable program components, can be implemented in hardware, or a combination of hardware, software, and/or firmware. For example, one or more application specific integrated circuits (ASICs) can be programmed to carry out one or more of the systems and procedures described herein.

Various techniques, or certain aspects or portions thereof, may take the form of program code (i.e., instructions) embodied in tangible media, such as floppy diskettes, CD-ROMs, hard drives, a non-transitory computer readable storage medium, or any other machine readable storage medium wherein, when the program code is loaded into and executed by a machine, such as a computer, the machine becomes an apparatus for practicing the various techniques. In the case of program code execution on programmable computers, the computing device may include a processor, a storage medium readable by the processor (including volatile and non-volatile memory and/or storage elements), at least one input device, and at least one output device. The volatile and non-volatile memory and/or storage elements may be a RAM, an EPROM, a flash drive, an optical drive, a magnetic hard drive, or another medium for storing electronic data. One or more programs that may implement or utilize the various techniques described herein may use an application programming interface (API), reusable controls, and the like. Such programs may be implemented in a high-level procedural or an object-oriented programming language to communicate with a computer system. However, the program(s) may be implemented in assembly or machine language, if desired. In any case, the language may be a compiled or interpreted language, and combined with hardware implementations.

Many of the functional units described in this specification may be implemented as one or more components, which is a term used to more particularly emphasize their implementation independence. For example, a component may be implemented as a hardware circuit comprising custom very large-scale integration (VLSI) circuits or gate arrays, off-the-shelf semiconductors such as logic chips, transistors, or other discrete components. A component may also be implemented in programmable hardware devices such as field programmable gate arrays, programmable array logic, programmable logic devices, or the like.

Components may also be implemented in software for execution by various types of processors. An identified component of executable code may, for instance, comprise one or more physical or logical blocks of computer instructions, which may, for instance, be organized as an object, a procedure, or a function. Nevertheless, the executables of an identified component need not be physically located together but may comprise disparate instructions stored in different locations that, when joined logically together, comprise the component and achieve the stated purpose for the component.

Indeed, a component of executable code may be a single instruction, or many instructions, and may even be distributed over several different code segments, among different programs, and across several memory devices. Similarly, operational data may be identified and illustrated herein within components and may be embodied in any suitable form and organized within any suitable type of data structure. The operational data may be collected as a single data set or may be distributed over different locations including over different storage devices, and may exist, at least partially, merely as electronic signals on a system or network. The components may be passive or active, including agents operable to perform desired functions.

Reference throughout this specification to “an example” means that a particular feature, structure, or characteristic described in connection with the example is included in at least one embodiment of the present disclosure. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present disclosure may be referred to herein along with alternatives for the various components thereof. It is understood that such embodiments, examples, and alternatives are not to be construed as de facto equivalents of one another but are to be considered as separate and autonomous representations of the present disclosure.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive.

Those having skill in the art will appreciate that many changes may be made to the details of the above-described embodiments without departing from the underlying principles of the disclosure. The scope of the present disclosure should, therefore, be determined only by the following claims.

### Examples

The following examples pertain to further embodiments.
Example 1 is a method for creating a snapshot of one or more cloud-network architecture framework resources with steps comprising identifying one or more application resources associated with one or more applications, wherein the one or more applications is associated with a namespace, identifying a plurality of persistent volume claims, identifying a plurality of storage volumes associated with the namespace, wherein each of the plurality of storage volumes is bound to at least one of the plurality of persistent volume claims, pausing transactions executed on each of the plurality of storage volumes, capturing a snapshot of each of the plurality of storage volumes, creating a copy of the one or more application resources, and capturing a namespace snapshot by capturing the snapshots of each of the plurality of storage volumes and the copy of the one or more application resources.
Example 2 is a method according to Example 1, further comprising resuming the transactions executed on at least a portion of the plurality of storage volumes and saving the namespace snapshot to a snapshot storage resource.
Example 3 is a method according to Example 1 or 2, further comprising wherein the snapshot storage resource is independent of and external to the namespace.
Example 4 is a method according to any of Examples 1-3, wherein importing the namespace snapshot into a second namespace, identifying a plurality of data blocks within a plurality of storage volumes, verifying there are no applications within the second namespace differing from applications captured by the namespace snapshot, and hydrating the plurality of data blocks with data from the namespace snapshot.
Example 5 is a method according to any of Examples 1-4, wherein each persistent volume claim is mounted to an application and exposed to application data, wherein application data comprises application metadata and application resources.
Example 6 is a method according to any of Examples 1-5, wherein the namespace snapshot further comprises undeployed application data.
Example 7 is a method according to any of Examples 1-6, wherein the namespace snapshot does not capture any ephemeral volumes bound to the namespace.
Example 8 is a method according to any of Examples 1-7, wherein pausing the data transactions comprises quiescing each of the plurality of storage volumes, and wherein the paused data transactions comprise input and output transactions to and from the plurality of storage volumes.
Example 9 is a method according to any of Examples 1-8, wherein the transactions on the plurality of storage volumes are paused approximately concurrently.
Example 10 is a system comprising one or more processors configured to execute instructions stored in a non-transitory computer readable storage medium, the instructions comprising identifying one or more application resources associated with one or more applications, wherein the one or more applications is associated with a namespace; identifying a plurality of persistent volume claims associated with a namespace, identifying a plurality of storage volumes associated with the namespace, wherein each of the plurality of storage volumes is bound to at least one of the plurality of persistent volume claims, pausing transactions executed on each of the plurality of storage volumes, and capturing a namespace snapshot by capturing a snapshot of each of the plurality of storage volumes.
Example 11 is a system according to Example 10, wherein resuming the transactions executed on at least a portion of the plurality of storage volumes, and saving the namespace snapshot to a snapshot storage resource.
Example 12 is a system according to Example 10 or 11, wherein the snapshot storage resource is independent of and external to the namespace.
Example 13 is a system according to any of Examples 10-12, the instructions further comprising importing the namespace snapshot into a second namespace, identifying a plurality of data blocks within a plurality of storage volumes, verifying there are no applications within the second namespace differing from applications captured by the namespace snapshot, and hydrating the plurality of data blocks with data from the namespace snapshot.
Example 14 is a system according to any of Examples 10-13, wherein each persistent volume claim is mounted to an application and exposed to application data, wherein application data comprises application metadata and application resources.
Example 15 is a system according to any of Examples 10-14, wherein the namespace snapshot further comprises undeployed application data.
Example 16 is a system according to any of Examples 10-15, wherein the namespace snapshot does not capture any ephemeral volumes bound to the namespace.
Example 17 is a system according to any of Examples 10-16, wherein pausing the data transactions comprises quiescing each of the plurality of storage volumes, and wherein the paused data transactions comprise input and output transactions to and from the plurality of storage volumes.
Example 18 is a system according to any of Examples 10-17, wherein the transactions on the plurality of storage volumes are paused approximately concurrently.
Example 19 is a non-transitory computer readable storage medium storing instructions for execution by one or more processors, the instructions comprising identifying a plurality of persistent volume claims associated with a namespace, identifying a plurality of storage volumes associated with the namespace, wherein each of the plurality of storage volumes is bound to at least one of the plurality of persistent volume claims, pausing transactions executed on each of the plurality of storage volumes, and capturing a namespace snapshot by capturing a snapshot of each of the plurality of storage volumes.
Example 20 is a non-transitory computer readable storage medium storing instructions for execution by one or more processors according to Example 19, the instructions further comprising resuming the transactions executed on at least a portion of the plurality of storage volumes, and saving the namespace snapshot to a snapshot storage resource.

1. A method comprising:
identifying one or more application resources associated with one or more applications, wherein the one or more applications is associated with a namespace;
identifying a plurality of persistent volume claims;
identifying a plurality of storage volumes associated with the namespace, wherein each of the plurality of storage volumes is bound to at least one of the plurality of persistent volume claims;
pausing transactions executed on each of the plurality of storage volumes;
capturing a snapshot of each of the plurality of storage volumes;
creating a copy of the one or more application resources; and
capturing a namespace snapshot by capturing the snapshots of each of the plurality of storage volumes and the copy of the one or more application resources.

2. The method of claim 1, further comprising:
resuming the transactions executed on at least a portion of the plurality of storage volumes; and
saving the namespace snapshot to a snapshot storage resource.

3. The method of claim 2, wherein the snapshot storage resource is independent of and external to the namespace.

4. The method of claim 1, further comprising:
importing the namespace snapshot into a second namespace;
identifying a plurality of data blocks within a plurality of storage volumes;
verifying there are no applications within the second namespace differing from the one or more resources captured by the namespace snapshot; and
hydrating the plurality of data blocks with data from the namespace snapshot.

5. The method of claim 1, wherein each persistent volume claim is mounted to an application and exposed to application data, wherein application data comprises application metadata.

6. The method of claim 1, wherein the namespace snapshot further comprises undeployed application metadata.

7. The method of claim 1, wherein the namespace snapshot does not capture any ephemeral volumes bound to the namespace.

8. The method of claim 1, wherein pausing the data transactions comprises quiescing each of the plurality of storage volumes, and wherein the paused transactions comprise input and output transactions to and from the plurality of storage volumes.

9. The method of claim 1, wherein the transactions on the plurality of storage volumes are paused approximately concurrently.

10. A system comprising one or more processors configured to execute instructions stored in a non-transitory computer readable storage medium, the instructions comprising:
identifying one or more application resources associated with one or more applications, wherein the one or more applications is associated with a namespace;
identifying a plurality of persistent volume claims associated with the namespace;
identifying a plurality of storage volumes associated with the namespace, wherein each of the plurality of storage volumes is bound to at least one of the plurality of persistent volume claims;
pausing transactions executed on each of the plurality of storage volumes; and
capturing a namespace snapshot by capturing a snapshot of each of the plurality of storage volumes.

11. The system of claim 10, the instructions further comprising:
resuming the transactions executed on at least a portion of the plurality of storage volumes; and
saving the namespace snapshot to a snapshot storage resource.

12. The system of claim 11, wherein the snapshot storage resource is independent of and external to the namespace.

13. The system of claim 10, the instructions further comprising:
importing the namespace snapshot into a second namespace;
identifying a plurality of data blocks within a plurality of storage volumes;
verifying there are no applications within the second namespace differing from applications captured by the namespace snapshot; and
hydrating the plurality of data blocks with data from the namespace snapshot.

14. The system of claim 10, wherein each persistent volume claim is mounted to an application and exposed to application data, wherein application data comprises application metadata and application resources.

15. The system of claim 10, wherein the namespace snapshot further comprises undeployed application data.

16. The system of claim 10, wherein the namespace snapshot does not capture any ephemeral volumes bound to the namespace.

17. The system of claim 10, wherein pausing the data transactions comprises quiescing each of the plurality of storage volumes, and wherein the paused transactions comprise input and output transactions to and from the plurality of storage volumes.

18. The system of claim 10, wherein the transactions on the plurality of storage volumes are paused approximately concurrently.

19. Non-transitory computer readable storage medium storing instructions for execution by one or more processors, the instructions comprising:
identifying a plurality of persistent volume claims associated with a namespace;
identifying a plurality of storage volumes associated with the namespace, wherein each of the plurality of storage volumes is bound to at least one of the plurality of persistent volume claims;
pausing transactions executed on each of the plurality of storage volumes; and
capturing a namespace snapshot by capturing a snapshot of each of the plurality of storage volumes.

20. The instructions of claim 19, further comprising:
resuming the transactions executed on at least a portion of the plurality of storage volumes; and
saving the namespace snapshot to a snapshot storage resource.
